(19) United States
(12) Patent Application Publication
(10) Pub. No.: US 2010/0082624 A1
(43) Pub. Date: Apr. 1, 2010

(54) SYSTEM AND METHOD FOR CATEGORIZING DIGITAL MEDIA ACCORDING TO CALENDAR EVENTS

(75) Inventors: Timothy B. Martin, Sunnyvale, CA (US); Gregory Charles Lindley, Sunnyvale, CA (US)

Correspondence Address: Apple Inc., 1000 Louisiana Street, Fifty-Third Floor, Houston, TX, 77002, US

(73) Assignee: Apple Inc., Cupertino, CA (US)

(21) Appl. No.: 12/242,813

(22) Filed: Sep. 30, 2008

(51) Int. Cl. G06F 17/30

(52) U.S. Cl. 707/737; 707/E17.009

(57) ABSTRACT

System and method for categorizing digital media based on correspondence between characteristics of individual digital media items and characteristics associated with one or more calendar events is disclosed. Data is acquired and processed for each of a plurality of digital media items that is representative of characteristics of each of the respective digital media items. Further, data is acquired and processed for each of a plurality of calendar events that is representative of characteristics of each of the respective calendar events. Then, a group of digital media items are related together based on matching characteristics of each digital media item in the group to characteristics of a calendar event.

### FIELD

This disclosure relates to categorizing digital media, and more particularly to a system and method for categorizing digital media based on correspondence between characteristics of individual digital media items and characteristics associated with one or more calendar events.

### BACKGROUND

Consumers have access to a wide variety of portable electronic devices that enable creation of digital media including, for example, digital cameras, digital video recorders, cell phones, smart phones, and digital sound recording devices, among others. These electronic devices are popular with consumers in part because they allow spontaneous creation of high-quality digital content whenever, and wherever the mood strikes. Still further, advances in digital media storage technology allow users to create and store large amounts of digital media. For example, a user can easily store thousands of high-quality pictures on a single flash memory storage chip. However, as capacities increase, the physical size of the media is decreasing. Where a 4″×5.75″×1″, 30 gigabyte hard drive was cutting edge in 1998, today a 32 gigabyte SD card has higher capacity, is less expensive, and is substantially smaller. And even so, other, smaller media are rapidly overtaking SD cards in capacity and cost.

Given these greater opportunities for digital storage, the ever expanding digital media libraries of most users have given rise to a desire to organize and often group the media items for better management. Often, users want to categorize their digital media based on several user specified criterion, such as time, date, and/or location of creation of the media. Also, the digital media can be categorized based on persons associated with the particular item of recorded digital media; for instance, groupings may be desired based on the persons appearing in photographs or the singers of songs. Other forms of categorizing digital media can be utilized as well. This categorizing process can be complicated and time consuming inasmuch as digital media libraries quickly grow beyond a manageable size to manually go through and label for categorization.

Many consumers utilize digital calendars. Frequently portable electronic devices such as PDAs and smart phones incorporate digital calendar features. Digital calendars may also take the form of computer programs that run locally on a user's desktop computer. Often portable electronic calendars synchronize with desktop computer based calendars. Alternatively, digital calendars can be stored remotely on a server and accessed through a web interface. In general, all digital calendars allow users to enter “events” into the calendar and which are defined based on periods in time. The present disclosure appreciates that digital media is often recorded/created in association with these events and it would be beneficial to be able to “categorize” media based on association with calendared events.

### SUMMARY

Additional features and advantages of the disclosure will be set forth in the description which follows, and in part will be obvious from the description, or may be learned through the practice of what is taught. The features and advantages of the disclosure may be realized and obtained by means of the instruments and combinations particularly pointed out in the patented claims. These and other features will become more fully apparent from the following description and the patented claims, or may be learned by the practice of that which is described.

This disclosure describes a system and method for categorizing digital media based on correspondence between characteristics of individual digital media items, such as photographs, and characteristics associated with one or more calendar events. Disclosed are systems, methods and computer readable media for categorizing such digital media based on correspondence between characteristics of individual media items and characteristics associated with one or more calendar events on a digital calendar such as iCal from Apple, Inc.

Aspects of the method described herein and the principles associated therewith are also applicable to the system and computer readable medium embodiments that are also described. Accordingly, a method of categorizing digital media (photographs) based on correspondence between characteristics of individual digital media items (date, time, location and/or people portrayed) and characteristics associated with one or more calendar events (date, time period, place and/or event attendees) is disclosed. The method includes acquiring, receiving and/or processing, for each of a plurality of digital media items, data representative of these types of characteristics of each of the respective digital media items. The method also includes acquiring, receiving and/or processing, for each of a plurality of calendar events, data representative of these similar types of characteristics of each of the respective calendar events. The method then includes relating a group of digital media items, such as photographs, together based on matching characteristics of each digital media item in the group to like or similar characteristics of a calendar event.

The matching characteristics of each digital media item in the group to that of a calendar event can include date and time.

The method may include another embodiment where the matching characteristics of each digital media item in the group to that of a calendar event includes date, time and likenesses {people, settings, things portrayed or other common feature(s) between items in the group}. In the instance of “likeness” representing people, likeness data for a calendar event can be derived from attendee data associated with the event. Likeness data for a digital media item can also be derived from facial recognition produced data. Additionally, likeness data for a digital media item can be derived from user-input identification data. For instance, a user can append metadata to a digital photograph specifying the persons depicted in the digital image.

In one embodiment, the matching characteristics of each digital media item in the group to that of a calendar event includes date, time and location. In this embodiment the location data for a calendar event can be derived from user-input location data, such as a specified meeting site in the calendar entry. The location data for a digital media item can be derived from GPS produced and associated data, or can be user-input.

The matching characteristic of each digital media item in the group to that of a calendar event can include an event label such as “Martha's Birthday.” An event label for a calendar event can be derived from user-input event data usually in the form of event title or subject. An event label for a digital media item would usually be derived from associated user-input data. Also, an event label for a digital media item can be derived from scene recognition data.

In a related aspect, once a group of media items has been defined as a group, the metadata defining, for example, the event label, can be used as input data to calendar the labeled event in a related calendar program application. For instance, if a group of photographs are each labeled as “Martha's Birthday” and time-wise the group spans the period from 6 pm to 10 pm, that data can be used to create a commensurate calendar entry, the subject of which is “Martha's Birthday” on the related calendar program.

Example image formats for digital media include JPG, GIF, and TIFF. Example video formats for digital media include WMV, AVI, MPG, and DIVX. A digital camera, for example, can embed data such as time, date, and location of creation of a digital media recording, such as a photograph.

In one aspect, the method categorizes digital media taken by a digital camera, digital media taken by a video recorder, and/or digital media taken by a digital sound recorder based on calendar events. The method applies to other types of digital media as well. As mentioned above, the calendar data can be stored locally and/or remotely. The principles described herein apply to any digital calendars from any provider.

### BRIEF DESCRIPTION OF THE DRAWINGS

In order to describe the manner in which the advantages and features of this disclosure can be obtained, a more particular description is provided below, including references to specific embodiments which are illustrated in the appended drawings. Understanding that these drawings depict only exemplary embodiments and are not therefore to be considered limiting, the subject matter will be described and explained with additional specificity and detail through the use of the accompanying drawings in which:

FIG. 1 illustrates an example system embodiment;

FIG. 2 illustrates an example calendar including events;

FIG. 3 illustrates an example method embodiment;

FIG. 4 illustrates digital media categorized according to calendar activities with matching dates/times;

FIG. 5 illustrates digital media categorized according to event labels;

FIG. 6 illustrates digital media categorized using, among other criteria, persons reflected in the media;

FIG. 7 illustrates digital media categorized according to Global Positioning Satellite (GPS) locations associated with the individual media items and identified with an event entered in the calendar; and

FIG. 8 illustrates digital media categorized according to user-set four hour intervals in the calendar.

### DETAILED DESCRIPTION

Various example embodiments of the categorization schemes for digital media are described in detail below. While specific implementations are discussed, it should be understood that this is done for illustration purposes only. A person skilled in the relevant art will recognize that other components and configurations may be used without parting from the spirit and scope of the disclosure.

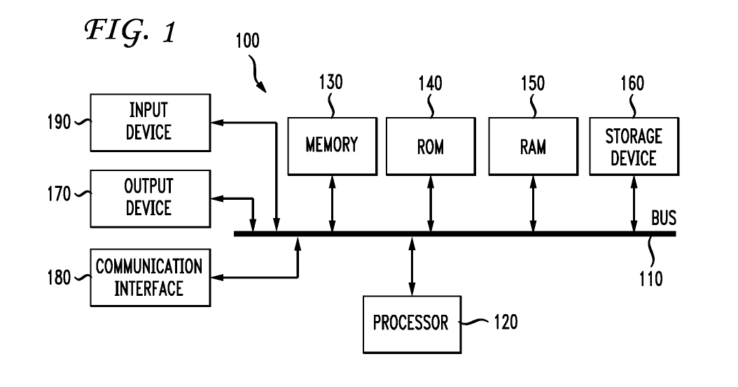

With reference to FIG. 1, an exemplary system includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the program may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up.

The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction requiring operation on any particular hardware arrangement and therefore the basic features here may easily be substituted for improved hardware or firmware arrangements as they are developed.

For clarity of explanation, the illustrative system embodiment is presented as comprising (including, but not limited to) individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

As noted above, the present disclosure enables the categorizing of digital media based on calendar events, such as events in iCal from Apple, Inc. Any digital media containing embedded information, such as time, date, and location, is contemplated as within the scope and spirit of this disclosure. Also, any calendar program capable of storing events is contemplated as within the scope of this disclosure.

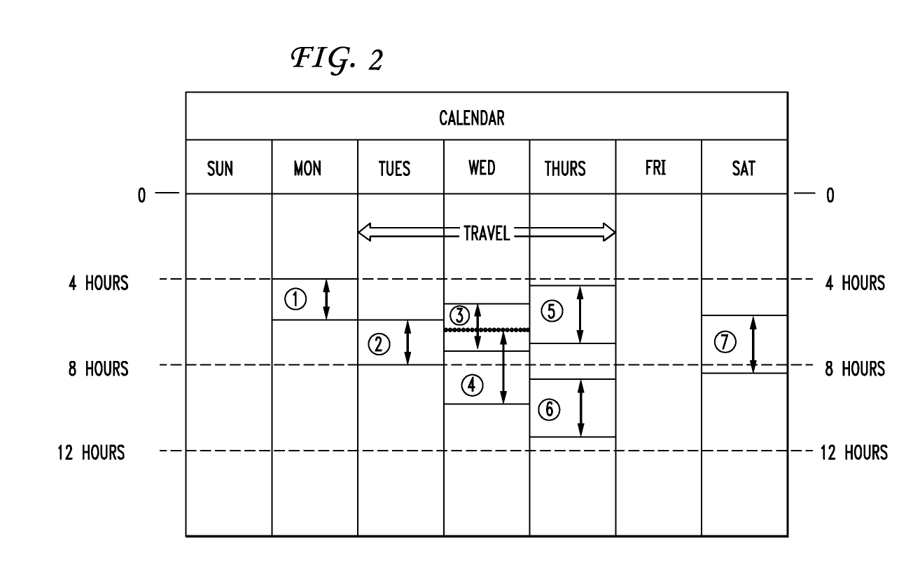

FIG. 2 illustrates a calendar with events. The example calendar of FIG. 2 shows one week, Sunday through Saturday. There are seven events shown on the calendar. Event 1 is scheduled on Monday. Event 2 is scheduled on Tuesday. Events 3 and 4 are on Wednesday and slightly overlap in time. Events 5 and 6 are on Thursday. Event 7 is on Saturday. An event's relative vertical position within a day indicates the designated time for that event. Four hour time increments are benchmarked for each day on the calendar. A user can label each event with information about the event, such as a name, start time, duration, persons attending, location, and other relevant information. The calendar also indicates that the events 2, 3, 4, 5 and 6 will occur during a travel period (Tuesday-Thursday).

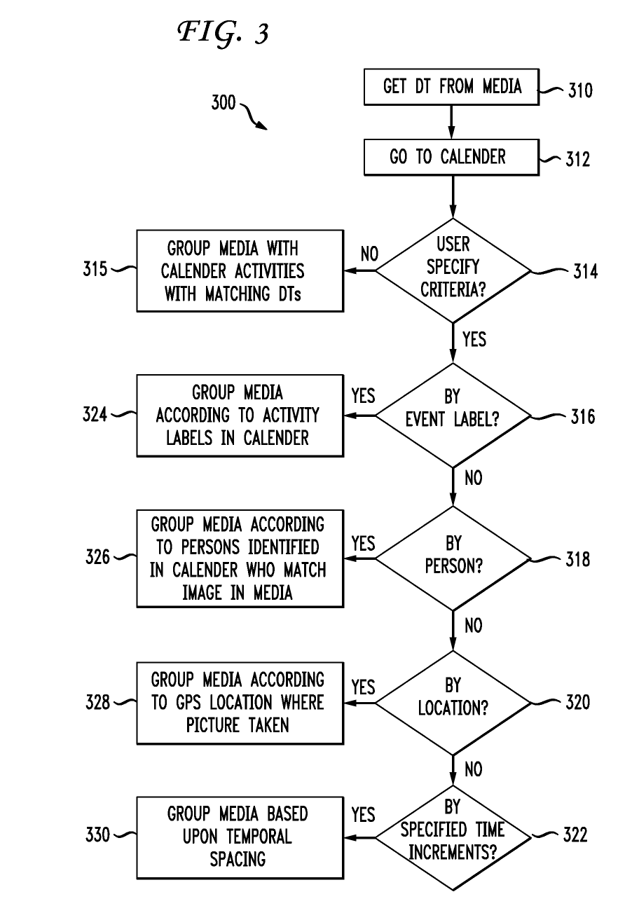

Having discussed some fundamental system components and fundamental calendaring concepts, the present description turns to the exemplary method embodiment that is depicted. At least in part, the method is discussed in terms of a system that is configured to practice the method. FIG. 3 charts an example of the method. A method of categorizing digital media based on calendar events 300 is disclosed. The system acquires/receives date/time/location data for digital media 310. The system communicates with a calendar program 312 and acquires/receives relevant information data. In this example, if no user criterion is specified 314, the system groups the digital media with calendar activities having matching dates and times 315. If a user specified criterion is by event label 316, then the system groups media according to activity labels in the calendar. If the user specified criterion is not by event label, then the system determines if the specified criterion is by person 318. If yes, the system groups media according to persons identified in the calendar who match images or likenesses depicted in the digital media. If no, the system determines if the specified criterion is by location 320. If yes, the system groups media according to location where the digital media was taken, and if no the system groups media based on a predetermined time interval 322.

Accordingly, FIG. 3 illustrates categorization methods based on user specified criterion, when specified. For example, if the user specified criterion is by event label 316, the system groups the digital media according to activity labels in the calendar 324. If the user specified criterion is by person 318, then the system groups the digital media according to persons identified in the calendar who match the images/likenesses depicted in the media 326. If the user specified criterion is by location 320, then the system groups the media according to GPS location or other location indicator of where the picture was taken 328. If the user specified criterion is temporal spacing 330, then items are grouped based on how time-wise close or far away they are from each other (i.e. within or without a specified time bandwidth). For instant, cluster groupings may be specified, with the constraint being a time period within which all members must occur. As an example, if a four hour time window is specified, all media items having a time stamp within four hours of each other will be grouped together. In contrast, a four hour spacing interval can be specified and media items will be grouped based on which side they fall of a four hour time space in which there is no time stamped items. For instance, if a series of time stamped photographs are being considered and a four hour spacing interval has been specified, then if there are no photographs stamped between 10 am and 2 pm, a pre-interval group will be defined, as well as a post-interval group. An illustration of this concept can be appreciated from FIG. 2 where events 5 and 6 are sufficiently spaced to establish the pre-interval group 5 and the post-interval group 6 on Thursday. In a related way, media items can be grouped based on the fact that all members are time stamped in a time period that falls between requisite blank time spaces. In this regard, if the required blank space is four hours and no photographs occur between 2 am and 6 am and then again from 6 pm to 10 pm, then all photographs time stamped between 6 am and 6 pm will be grouped together.

As explained above, the system and method can also group other forms of digital media according to location where the digital media was created.

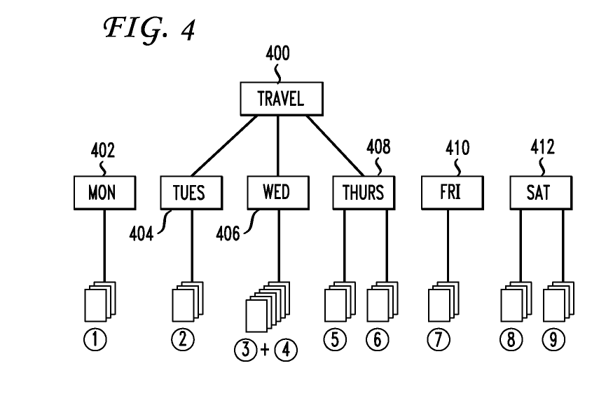

FIG. 4 illustrates digital media, photos in this example, categorized according to calendar activities with corresponding dates and/or times. The system categorizes pictures taken on Monday that depict an event scheduled on Monday 402 into Group 1. The system categorizes pictures taken on Tuesday of an event scheduled on Tuesday 404 into Group 2. The system categorizes pictures taken on Wednesday into a group 406 that contains pictures from event 3 and event 4. In this embodiment, the system categorizes the pictures taken during event 3 and event 4 into the same group 406 because they overlap at least partially in time. However, other embodiments can be implemented that treat overlapping events differently. For example, the system can place pictures exclusively from event 3 and exclusively from event 4 in separate groups. In this embodiment the system will then place digital media recorded during the overlap of the events into both groups.

The system categorizes pictures having a date and time corresponding to a first event scheduled on Thursday 408 into group 5. The system categorizes pictures having a date and time corresponding to a second event scheduled on Thursday 410 into group 6. The system categorizes pictures having a date and time corresponding to an event scheduled on Friday 412 into group 7. The system categorizes pictures having a date and time corresponding to a first event scheduled on Saturday 414 into group 8. The system categorizes pictures having a date and time corresponding to a second event scheduled on Friday 412 into group 9. The system categorizes all digital media having a date and time corresponding to Tuesday, Wednesday, and Thursday as taken while on travel as a group 400. The system can employ various mechanisms to determine whether or not a picture of an event, for example, was taken during the scheduled event, for example using time, GPS location information, scene detection, face identification, and the like. As an example, if a user is calendared as being on vacation in the Bahamas and a picture taken during the scheduled vacation time includes snow, the system can determine that the picture is not at the scheduled location, using for example, scene detection and analysis tools. While this is an extreme example, the same fundamental principle applies to more subtle details in media content, as well.

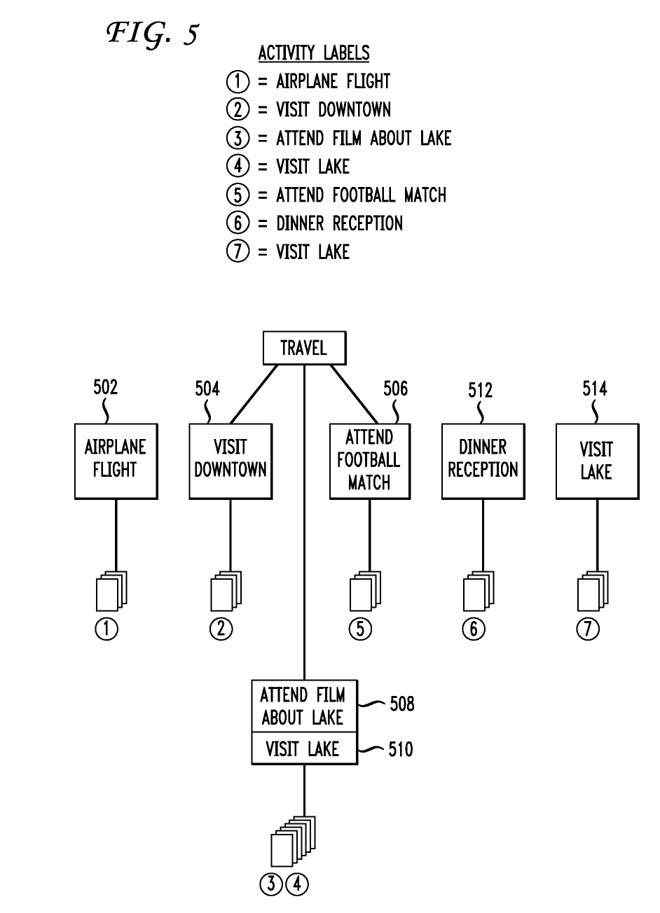

FIG. 5 illustrates digital media categorized according to applied event labels to the media items and activity/meeting names in the calendar. The system groups a first set of digital pictures according to an airplane flight 502. The date and time associated with the creation of these pictures coincide with the event, meeting name, date, and time stored in the calendar. The system groups a second set of digital pictures according to a visit downtown 504. The system categorizes and combines third and fourth sets of digital pictures into a single group containing pictures taken while attending a film about a lake 508 and visiting the lake 510. In this embodiment, the system categorizes pictures taken while attending the film about a lake and visiting the lake into the same group 406 because they overlap at least partially in time. However, other embodiments can be implemented that treat overlapping events in a different manner. For example, the system can place pictures taken while attending the film about the lake and while visiting the lake into separate groups even though these events overlap.

The system groups a fifth set of digital pictures taken while attending a football match 506. The system groups a sixth set of digital pictures taken during a dinner reception 512. The system groups a seventh set of digital pictures taken while visiting a lake 514. The system additionally categorizes the second through fifth groups of digital pictures as occurring during travel corresponding to the travel calendar event listed on the calendar of FIG. 2.

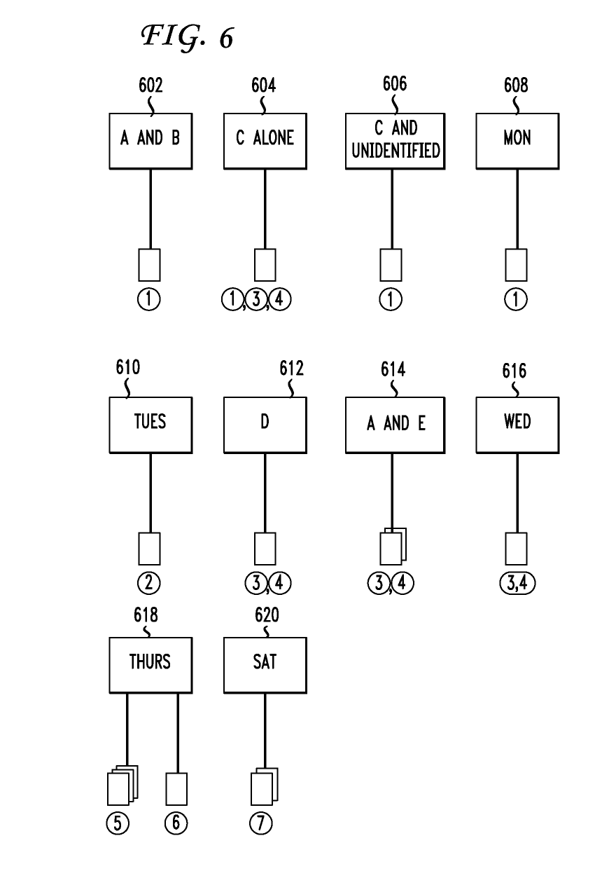

FIG. 6 illustrates digital media categorized according to persons identified in the calendar. For example, in one embodiment, the calendar identifies persons A, B, and C as participants in seven activities. Various groups can be defined. The system then categorizes pictures into groups based on persons identified in the calendar. For example, the system categorizes digital media into a group in which person A and person B appear together. The system can categorize digital media into a group in which person C appears alone. Furthermore, this embodiment provides a way to categorize unidentified persons in the digital pictures. The system can categorize digital media into a group in which person C appears with an unidentified person. The system can categorize pictures containing no identified people into a default category or into groups based on the day the picture was taken. Other methods of categorizing unidentified persons can be utilized as well. Facial recognition technologies can assist in identifying persons in a digital picture, for example. Other forms of identifying persons in a picture can also be implemented. Voice recognition can assist in identifying persons in digital sound media.

Turning back to FIG. 6, the system categorizes digital pictures according to persons identified in the calendar. The system categorizes pictures containing images of persons A and B 602 into a group. The system categorizes pictures containing images of person C alone 604 into another group. Pictures of person C alone were found in the digital media taken at location 1, location 3, and location 4. The system finds a picture of person C with an unidentified person 606 in the digital media taken at location 1 and categorizes it accordingly. The system categorizes one picture with an unidentified person from event 1 into a group labeled “Monday” 608, which is the date the picture was taken.

The system categorizes pictures containing images of person D 612 into another group. This group contains all images of D, whether D is alone or with other persons. In this example, the digital pictures containing D are found in the pictures taken of event 3 and event 4.

The system categorizes pictures containing images of persons A and E 614 into another group. In this example, the digital pictures containing A and E are found in the pictures taken of event 3 and event 4. The system categorizes one picture with unidentified persons from event 3 or event 4 into a default group labeled “Wednesday” 616, which is the date the picture was taken.

The system labels three images taken during event 5 containing unidentified persons only as “Thursday” 618, which is the date the pictures were taken. Additionally, the system categorizes and labels an image taken during event 6 containing unidentified persons into the same “Thursday” 618 group, which is the date the picture was taken.

Also, FIG. 6 shows two images taken during event 7 on the calendar as being categorized and labeled as “Saturday” 620, which is the date the picture was taken. As noted above, other default methods can be defined to categorize digital media containing no identified persons.

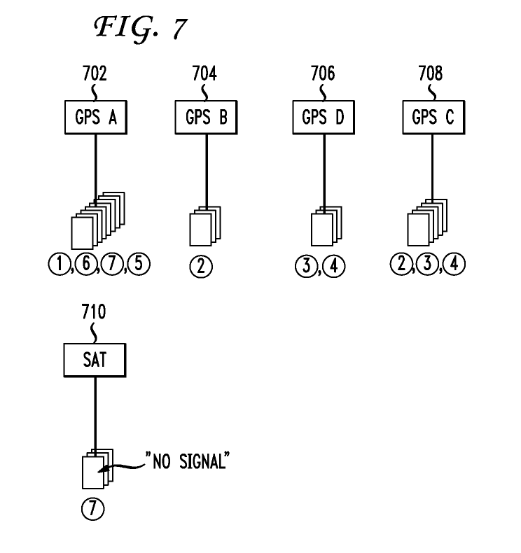

FIG. 7 illustrates one way to categorize digital media according to GPS location corresponding to location or site identified in a calendar. As an example, a user may label multiple events as occurring at a stored “home” location. The digital media taken at the GPS location corresponding to the “home” location will be categorized into a group.

For example, the system categorizes pictures taken at GPS location A 702 which correspond to the same location identified in the calendar into a group. This group of location A pictures includes pictures taken during first, sixth, seventh, and eighth events in the corresponding calendar.

The system categorizes pictures taken at GPS location B 704 which correspond to the same location identified in the calendar into a group. This group of location B pictures was taken during the second event in the corresponding calendar.

The system categorizes pictures taken at GPS location D 706 that correspond to the same location identified in the calendar into a group. This group of location D pictures includes pictures taken during the third or fourth events in the corresponding calendar. In this example, the system combines the overlapping events of event 3 and event 4 into one group for categorizing. Other methods of treating overlapping events can be implemented as well and as described hereinabove.

The system categorizes pictures taken at GPS location C 708 that correspond to the same location identified in the calendar into a group. This group of location C pictures was taken during the second, third, and fourth event in the corresponding calendar.

When location is the user specified criteria for media grouping, the system categorizes media items (pictures) having no GPS location information at the time of creation of the digital media into a group. In this example, the system groups pictures with no location information based on the day the pictures were taken, by default. As shown, the system categorizes pictures from event seven that have no location information into a group named “Saturday”. This label represents the day that the pictures having no location information were taken. Other default methods can be implemented to categorize pictures with no GPS location information. Although this example utilizes GPS signals to decipher location, the system can utilize other ways of recording location such as triangulation using cell phone towers, scene recognition and the like.

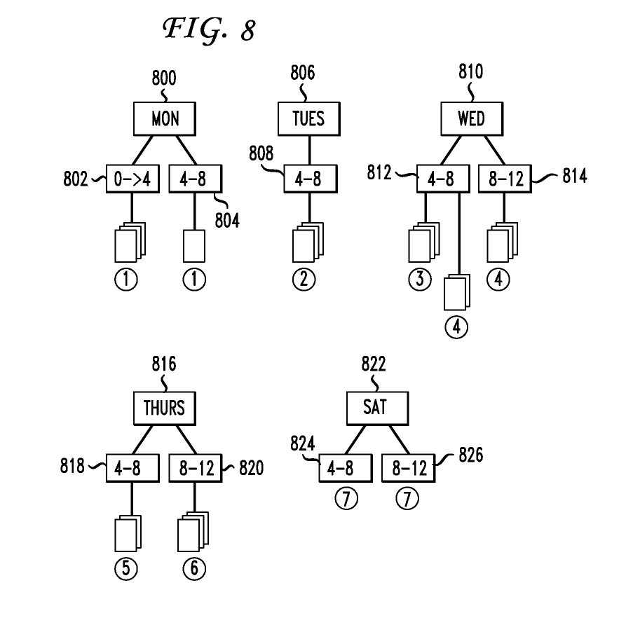

FIG. 8 illustrates digital media categorized according to user-set event four hour intervals in the calendar. For example digital pictures taken on Monday 800 are categorized into two groups. This correlates to the Monday shown on the calendar of FIG. 2. The first group “0->4” 802 contains pictures taken in the zero to four time interval on Monday. This group can correspond to 8:00 am to noon, for example. The second group “4->8” 804 contains pictures taken in the four to eight time interval on Monday. This group can correspond to 1:00 pm to 5:00 pm, for example. A user can vary the exact temporal position of a four hour block, if desired. Four hour blocks need not cover contiguous times and “touch” each other on the calendar.

The system categorizes digital pictures taken on Tuesday 806 into a group. The group “4->8” 808 contains pictures taken in the four to eight time interval on Tuesday. The system categorizes digital pictures taken on Wednesday 800 of the corresponding calendar week into two groups. The first group “4-8” 812 contains pictures taken in the four to eight time interval on Wednesday. The second group “8->12” 814 contains pictures taken in the eight to twelve time interval on Wednesday.

The system categorizes digital pictures taken on Thursday 816 of the corresponding calendar week into two groups. The first group “4->8” 818 contains pictures taken in the four to eight time interval on Thursday. The second group “8->12” 820 contains pictures taken in the eight to twelve time interval on Thursday.

The system categorizes digital pictures taken on Saturday 800 of the corresponding calendar day into two groups. The first group “4->8” 802 contains pictures taken in the four to eight time interval on Saturday. The second group “8->12” 826 contains pictures taken in the eight to twelve time interval on Saturday.

FIG. 8 illustrates events that have at least one picture for an indicated day and four-hour time interval. For example, the system categorizes digital pictures into the Monday “0->4” group which were taken during the first corresponding calendar event.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. A “tangible” computer-readable medium expressly excludes software per se (not stored on a tangible medium) and a wireless, air interface. Thus, any such connection is properly termed a computer-readable medium. Combinations of the above should also be included within the scope of the computer-readable media.

Computer-executable instructions include, for example, instructions and data that cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. Program modules may also comprise any tangible computer-readable medium in connection with the various hardware computer components disclosed herein, when operating to perform a particular function based on the instructions of the program contained in the medium.

Those of skill in the art will appreciate that other embodiments of this disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the above description may contain specific details, they should not be construed as limiting the claims in any way. Other configurations of the described embodiments are part of the scope of this disclosure. Accordingly, the patented claims and their legal equivalents shall only define the invention(s), rather than any specific examples described herein.

We claim:

1. A method for categorizing digital media based on correspondence between characteristics of individual digital media items and characteristics associated with one or more calendar events, said method comprising:
processing, for each of a plurality of digital media items, data representative of characteristics of each of the respective digital media items and, for each of a plurality of calendar events, data representative of characteristics of each of the respective calendar events; and
relating a group of digital media items together based on matching characteristics of each digital media item in the group to characteristics of a calendar event determined in the processing of the data.

2. The method as recited in claim 1, wherein the matching characteristics of each digital media item in the group to that of a calendar event comprises date, time, location and likenesses.

3. The method as recited in claim 1, wherein the matching characteristics of each digital media item in the group to that of a calendar event comprises date and time.

4. The method as recited in claim 1, wherein the matching characteristics of each digital media item in the group to that of a calendar event comprises date, time and likenesses.

5. The method as recited in claim 4, wherein likeness data for a calendar event is derived from attendee data associated with the event.

6. The method as recited in claim 5, wherein likeness data for a digital media item is derived from facial recognition produced data.

7. The method as recited in claim 5, wherein likeness data for a digital media item is derived from user-input identification data.

8. The method as recited in claim 1, wherein the matching characteristics of each digital media item in the group to that of a calendar event comprises date, time and location.

9. The method as recited in claim 8, wherein location data for a calendar event is derived from user-input location data.

10. The method as recited in claim 9, wherein location data for a digital media item is derived from GPS produced data.

11. The method as recited in claim 9, wherein likeness data for a digital media item is derived from user-input identification data.

12. The method as recited in claim 1, wherein the matching characteristics of each digital media item in the group to that of a calendar event comprises an event label.

13. The method as recited in claim 12, wherein an event label for a calendar event is derived from user-input event data.

14. The method as recited in claim 13, wherein an event label for a digital media item is derived from user-input data.

15. The method as recited in claim 13, wherein an event label for a digital media item is derived from scene recognition data.

16. A system for categorizing digital media based on correspondence between characteristics of individual digital media items and characteristics associated with one or more calendar events, said system comprising:
a module to process, for each of a plurality of digital media items, data representative of characteristics of each of the respective digital media items and, for each of a plurality of calendar events, data representative of characteristics of each of the respective calendar events; and
a module to relate a group of digital media items together based on matching characteristics of each digital media item in the group to characteristics of a calendar event.

17. The system as recited in claim 16, wherein the matching characteristics of each digital media item in the group to that of a calendar event comprises date and time.

18. The system as recited in claim 16, wherein the matching characteristics of each digital media item in the group to that of a calendar event comprises date, time and likenesses.

19. The system as recited in claim 18, wherein likeness data for a calendar event is derived from attendee data associated with the event.

20. The system as recited in claim 19, wherein likeness data for a digital media item is derived from facial recognition produced data.

21. The system as recited in claim 19, wherein likeness data for a digital media item is derived from user-input identification data.

22. The system as recited in claim 16, wherein the matching characteristics of each digital media item in the group to that of a calendar event comprises date, time and location.

23. The system as recited in claim 22, wherein location data for a calendar event is derived from user-input location data.

24. The system as recited in claim 23, wherein location data for a digital media item is derived from GPS produced data.

25. The system as recited in claim 23, wherein likeness data for a digital media item is derived from user-input identification data.

26. The system as recited in claim 16, wherein the matching characteristics of each digital media item in the group to that of a calendar event comprises an event label.

27. The system as recited in claim 16, wherein an event label for a calendar event is derived from user-input event data.

28. The system as recited in claim 27, wherein an event label for a digital media item is derived from user-input data.

29. The system as recited in claim 27, wherein an event label for a digital media item is derived from scene recognition data.

30. A tangible computer-readable medium storing instructions for categorizing digital media based on calendar events, the instructions comprising:
acquiring data descriptive of each of a plurality of digital media items and determining corresponding characteristics of each of the respective digital media items;
acquiring data descriptive of each of a plurality of calendar events and determining corresponding characteristics of each of the respective calendar events; and
relating a group of digital media items together based on matching characteristics of each digital media item in the group to characteristics of a calendar event.
